(19) United States
(12) Patent Application Publication
(10) Pub. No.: US 2005/0117057 A1
(43) Pub. Date: Jun. 2, 2005

(54) Video signal receiving apparatus and video signal receiving method, and video signal recording/reproducing apparatus and video signal recording/reproducing method

(75) Inventor: Shuichi Hisatomi, Fuchu-shi (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/995,534

(22) Filed: Nov. 24, 2004

(30) Foreign Application Priority Data
Nov. 28, 2003 (JP) 2003-400904

(51) Int. Cl. H04N 7/00; H04N 5/781

(52) U.S. Cl. 348/465; 386/125; 386/46

(57) ABSTRACT

The video signal receiving apparatus comprises a receiving unit configured to receive a video signal on which frequency information for viewing limit is multiplexed during a video blanking period of a specific line in an interlace system, an output unit configured to selectively output the received video signal in an interlaced state or in a state of being converted into a progressive video signal, a detecting unit configured to detect the frequency information for viewing limit which is multiplexed during the video blanking period from the received video signal, and a controller configured to limit an output of the video signal from the output unit when the output unit is requested to output a progressive video signal in a state where the frequency information is detected.

### CROSS-REFERENCE TO RELATED APPLICATIONS

This application is based upon and claims the benefit of priority from prior Japanese Patent Application No. 2003-400904, filed Nov. 28, 2003, the entire contents of which are incorporated herein by reference.

### BACKGROUND OF THE INVENTION

1. Field of the Invention

The present invention relates to a video signal receiving apparatus and a video signal receiving method for receiving and video-displaying, for example, TV broadcasting or the like. The present invention further relates to a video signal recording/reproducing apparatus and a video signal recording/reproducing method for recording/reproducing a video signal in a recording medium such as disk.

2. Description of the Related Art

As is well known, in recent years, a high-density recording technique for information has been promoted, and an optical disk having a recording capacity of 4.7 GB (Giga Byte) per layer on one side has been made practical.

An optical disk of this type includes, for example, a reproduction-only DVD-ROM (Digital Versatile Disk-Read Only Memory), a rewritable DVD-RAM (Random Access Memory), a DVD-RW (Rewritable), and a write-once type DVD-R (Recordable).

An optical disk recording/reproducing apparatus which records/reproduces data in/from a recordable DVD of this type can record and reproduce an NTSC (National Television System Committee) analog video signal received in a television tuner.

A system for multiplexing various information during a video blanking period and achieving various functions is established for an analog video signal to be recorded. Formats of this system standard are defined by EIA (Electronic Industries Association).

One of the formats defines a system where information contained in the video blanking period of the NTSC analog video signal is stored in a user data area set for each 1GOP (Group Of Picture) based on the MPEG (Moving Picture Experts Group) standard in a packet structure called XDS (Extended Data Service).

One function capable of multiplexing information during the video blanking period of the analog video signal is a viewing limit function for broadcast programs. This viewing limit function controls such that a program cannot be viewed when the programs added with frequency information for viewing limit are broadcasted and the frequency information substantially exceeds a frequency set by a viewer at the receiving side.

The optical disk recording/reproducing apparatus can record not only the analog video signal but also the frequency information for viewing limit.

The system for multiplexing various information during the video blanking period of the NTSC analog video signal defined by EIA intends an interlace system (480i). In this case, an XDS packet is stored in 284-line. The television also assumes an interlace signal form.

Contrary to this fact, in a current optical disk recording/reproducing apparatus, instead of the interlaced video signal (480i) which composes 1 frame of 1/30 seconds, there is increased a model having a function of outputting a progressive video signal (480p) which composes 1 frame of 1/60 seconds, which is twice the 480i signal, such as an NTSC analog video signal.

Thus, even when the optical disk recording/reproducing apparatus records the 480i video signal containing the frequency information for viewing limit, if the 480i video signal is converted into the 480p video signal to be output when reproducing, the signal inputting is below standard. Thus, the television cannot acquire the frequency information for viewing limit and the viewing limit cannot be achieved.

Jpn. Appln. KOKAI Publication No. 2000-40303 describes a configuration in which information indicating a total playing time in TOC (Table Of Contents) is previously stored as identification information for identifying a video CD (Compact Disk) whose reproduction is limited, and the video CD is permitted to be reproduced when the information indicating a total playing time acquired from the TOC of the loaded video CD is not contained in the previously stored identification information.

However, Jpn. Appln. KOKAI Publication No. 2000-40303 describes nothing about a response for inconvenience that viewing limit is not performed when the 480i video signal containing the frequency information for viewing limit is converted into the 480p video signal to be output when reproducing the optical disk having the 480i video signal recorded therein.

### BRIEF SUMMARY OF THE INVENTION

According to one aspect of the present invention, there is provided a video signal receiving apparatus comprising: a receiving unit configured to receive a video signal on which frequency information for viewing limit is multiplexed during a video blanking period of a specific line in an interlace system; an output unit configured to selectively output the video signal received in the receiving unit in an interlaced state or in a state of being converted into a progressive video signal; a detecting unit configured to detect frequency information for viewing limit which is multiplexed during the blanking period from the video signal received in the receiving unit; and a controller configured to, when the output unit is requested to output a progressive video signal in a state where the frequency information is detected in the detecting unit, limit an output of the video signal from the output unit.

According to one aspect of the present invention, there is provided a video signal receiving method comprising: receiving a video signal on which frequency information for viewing limit is multiplexed during a video blanking period of a specific line in an interlace system; selectively outputting the received video signal in an interlaced state or in a state of being converted into a progressive video signal; detecting the frequency information for viewing limit which is multiplexed during the video blanking period from the received video signal; and when a request is made to output the progressive video signal in a state where the frequency information is detected, limiting an output of the video signal.

According to one aspect of the present invention, there is provided a video signal recording/reproducing apparatus comprising: a recording unit configured to record in a recording medium a video signal on which frequency information for viewing limit is multiplexed during a video blanking period of a specific line in an interlace system; a reproducing unit configured to reproduce a video signal from the recording medium and selectively output the same in an interlaced state or in a state of being converted into a progressive video signal; a detecting unit configured to detect the frequency information for viewing limit which is multiplexed during the video blanking period from the video signal reproduced in the reproducing unit; and a controller configured to, when the reproducing unit is requested to output a progressive video signal in a state where the frequency information is detected in the detecting unit, limit an output of the video signal from the reproducing unit.

According to one aspect of the present invention, there is provided a video signal recording/reproducing method comprising: recording in a recording medium a video signal on which frequency information for viewing limit is multiplexed during a video blanking period of a specific line in an interlace system; reproducing the video signal from the recording medium and selectively outputting the same in an interlaced state or in a state of being converted into a progressive video signal; detecting the frequency information for viewing limit which is multiplexed during the video blanking period from the reproduced video signal; and when a request is made to output the progressive video signal in a state where the frequency information is detected, limiting an output of the video signal.

### BRIEF DESCRIPTION OF THE SEVERAL VIEWS OF THE DRAWING

FIG. 1 is a block configuration diagram for explaining an optical disk recording/reproducing apparatus according to one embodiment of the present invention;

FIG. 2 is a flowchart for explaining one example of a viewing limit operation to be performed by the optical disk recording/reproducing apparatus according to the embodiment; and

FIG. 3 is a flowchart for explaining another example of the viewing limit operation to be performed by the optical disk recording/reproducing apparatus according to the embodiment.

### DETAILED DESCRIPTION OF THE INVENTION

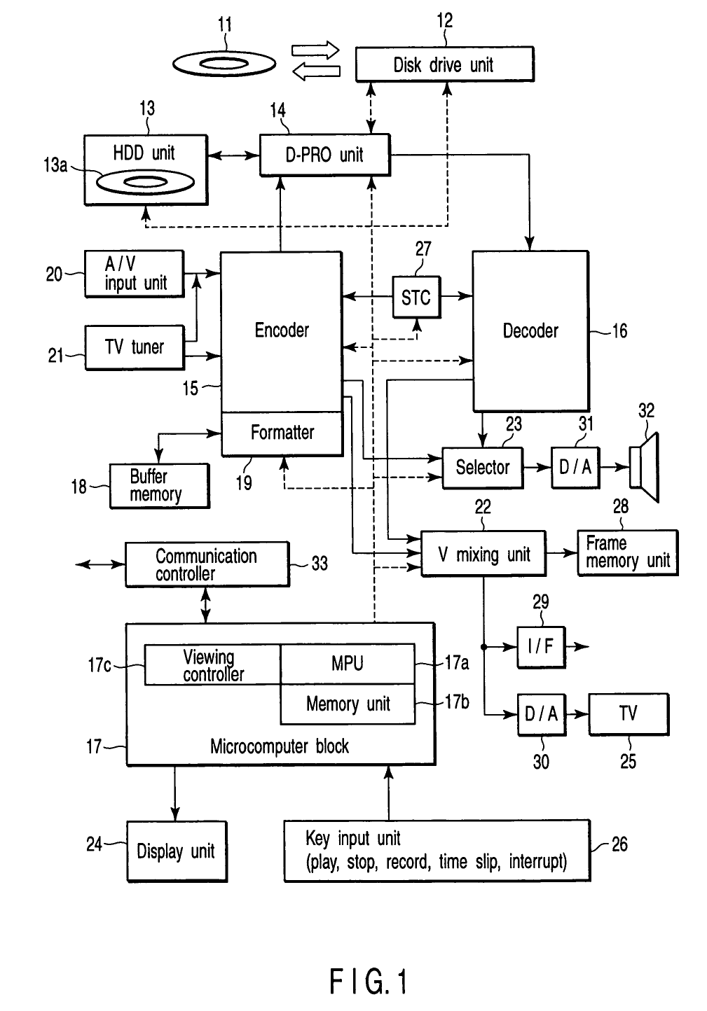

One embodiment according to the present invention will be described below in detail with reference to the drawings. FIG. 1 shows in detail an optical disk recording/reproducing apparatus to be explained in this embodiment. This optical disk recording/reproducing apparatus is configured to handle both an optical disk such as DVD that is recordable as a recording medium and a hard disk, but, for example, a semiconductor memory may be employed for the recording medium.

In other words, the optical disk recording/reproducing apparatus shown in FIG. 1 is roughly divided into a main block for recording on the left of the drawing, a main block for reproducing on the right thereof, and a main block for control on the bottom thereof.

This optical disk recording/reproducing apparatus has two types of disk drive units. The apparatus has a disk drive unit 12 which rotation-drives an optical disk 11 as a first medium which is an information recording medium capable of constructing a video file and performs reading/writing of information. This optical disk recording/reproducing apparatus further has an HDD (Hard Disk Drive) unit 13 for driving a hard disk 13a as a second medium.

A D-PRO (Data-Processor) unit 14 can supply recorded data to the disk drive unit 12 and the HDD unit 13 and further can receive reproduced signals. The disk drive unit 12 has a rotation control system, a laser drive system, an optical system, and the like for the optical disk 11. The D-PRO unit 14 handles data for recording or reproducing, and includes a buffer circuit, a modulation/demodulation circuit, an error correction unit, and the like.

This optical disk recording/reproducing apparatus is mainly configured of an encoder 15 constituting the recording side, a decoder 16 constituting the reproducing side, and a microcomputer block 17 for controlling the operation of the optical disk recording/reproducing apparatus.

The encoder 15 has an analog/digital converter for video and audio, which digitizes input analog video signal and analog audio signal, a video encoder, and an audio encoder. The encoder 15 further includes a sub-video encoder.

An output from the encoder 15 is converted into a predetermined DVD video format in a formatter 19 including a buffer memory 18, and is supplied to the D-PRO unit 14.

To the encoder 15, an external analog video signal and an external analog audio signal acquired from an A/V (Audio Video) input unit 20, or an analog video signal and an analog audio signal acquired from a TV (Television) tuner 21 are input.

When compressed digital video signal and digital audio signal are directly input in the encoder 15, the encoder 15 can supply the compressed digital video signal and digital audio signal directly to the formatter 19.

The encoder 15 can supply the digital video signal and audio signal which are analog/digital converted directly to a V (Video) mixing unit 22 and an audio selector 23.

In the video encoder included in the encoder 15, a digital video signal is converted into a digital video signal compressed in a variable bit rate based on the MPEG (Moving Picture Experts Group) 2 or MPEG1 standard. A digital audio signal is converted into a digital audio signal compressed in a constant bit rate or a liner PCM (Pulse Code Modulation) digital audio signal based on the MPEG or AC (Audio Compression)-3 standard.

When a sub-video signal is input from the A/V input unit 20 (for example, a signal from a separate output terminal equipped DVD video player of the sub-video signal), or when a DVD video signal having such a data structure is broadcasted and the channel is selected in the TV tuner 21, the sub-video signal in the DVD video signal is encoded in the sub-video encoder (run-length encoded) to be a bitmap of the sub-video.

The encoded digital video signal, digital audio signal, and sub-video signal are packed in the formatter 19 to be a video pack, an audio pack, and a sub-video pack, respectively, and further these packs are collected and converted into formats defined by the DVD video standards [for example, standards for recording in a DVD-RAM (Random Access Memory), DVD-RW (Rewritable), or DVD-R (Recordable)], respectively.

The optical disk recording/reproducing apparatus shown in FIG. 1 can supply information (packs of video, audio, sub-video signals, and the like) formatted in the formatter 19 and management information created therein to the HDD unit 13 or the disk drive unit 12 via the D-PRO unit 14 and record the supplied information in the hard disk 13a or the optical disk 11.

The information recorded in the hard disk 13a or the optical disk 11 can be recorded in the optical disk 11 or the hard disk 13a via the D-PRO unit 14 and the disk drive unit 12.

The microcomputer block 17 includes an MPU (Micro Processing Unit) 17a, a memory unit 17b, a viewing controller 17c, and the like. The memory 17b includes a ROM (Read Only Memory) having stored therein various control programs to be executed by the MPU 17a.

The memory unit 17b includes a RAM for providing a work area required for executing a program to the MPU 17a, and a non-volatile RAM for holding acquired EPG information, an electronic listing created based thereon, information on a date when the EPG information is acquired, and the like.

Further, the viewing controller 17c, though described in detail later, controls an output video signal based on the viewing limit information contained in the input analog video signal.

The contents to be notified to a user among the execution results of the microcomputer block 17 are displayed on a display unit 24 incorporated in the optical disk recording/reproducing apparatus or OSD (On Screen Display)-displayed on a TV receiver 25 connected to the outside. This TV receiver 25 functions to achieve the viewing limit when a 480i video signal containing the frequency information for viewing limit is input.

The microcomputer block 17 has a key input unit 26 which gives an operation signal for operating this optical disk recording/reproducing apparatus.

A timing at which the microcomputer 17 controls the disk drive unit 12, the HDD unit 13, the D-PRO unit 14, the encoder 15, and the decoder 16 can be defined based on time data from an STC (System Time Clock) 27. The operation such as recording or reproducing is performed in synchronization with a time clock from the STC 27, and other processing is performed at a timing independent from the time clock from the STC 27.

The decoder 16 has a separator for separating and extracting each pack from a DVD video format signal having a pack structure, a memory used for performing pack separating and other signal processing, a V decoder for decoding a video signal (contents of a video pack) separated in the separator, an SP (Sub Picture) decoder for decoding a sub-video signal (contents of a sub-video pack) separated in the separator, and an A (Audio) decoder for decoding an audio signal (contents of an audio pack) separated in the separator. The decoder 16 further comprises a video processor for appropriately combining a decoded sub-video with a decoded video and superimposing a menu, a highlight button, a caption, and other sub-video on the video to output the same.

The output video signal from the decoder 16 is input in the V mixing unit 22. The V mixing unit 22 combines text data. This V mixing unit 22 is connected with a line for directly fetching a signal from the TV tuner 21 or the A/V input unit 20.

The V mixing unit 22 is connected with a frame memory unit 28 used as a buffer. When an output from the V mixing unit 22 is an analog output, the output is output to the outside via an I/F (Interface) 29, and when the output is a digital output, the output is output to the external TV receiver 25 via a D/A (Digital/Analog) converter 30.

An output audio signal from the decoder 16 is analog-converted in a D/A converter 31 via the selector 23 and is output to a speaker 32 incorporated in the TV receiver 25. The selector 23 is controlled by a select signal from the microcomputer block 17.

Thus, when the selector 23 directly monitors a digital signal from the A/V input unit 20 or the TV tuner 21, the selector 23 can directly select the signal having passed through the encoder 15.

The microcomputer block 17 is connected by a communication controller 33 compatible with, for example, Ethernet, such that data communication can be made with an external network via a communication line.

This optical disk recording/reproducing apparatus can record a 480i video signal input via the A/V input unit 20 or the TV tuner 21 in the optical disk 11 or the hard disk 13a, and reproduce the 480i or 480p video signal.

In this case, when the frequency information for viewing limit is contained in the input 480i video signal, the frequency information is also recorded. When the 480i video signal is output when reproducing, the frequency information for viewing limit is correctly added to the video signal and is output according to the standard, so that the TV receiver 25 can detect the frequency information to correctly perform viewing limit.

However, when the 480p video signal is output when reproducing, the TV receiver 25 cannot detect the frequency information for viewing limit from the video signal, and thus, the viewing limit cannot be achieved.

Then, the microcomputer block 17 controls by the viewing controller 17 such that the above problem does not occur.

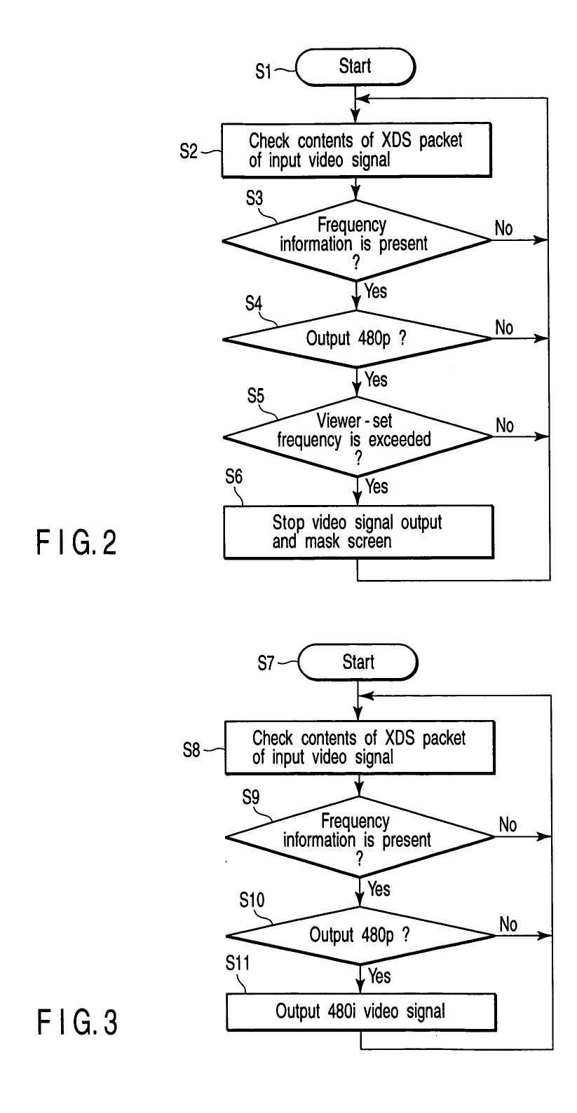

FIG. 2 is a flowchart showing one example of the control operation using this viewing controller 17c. In other words, when started (step S1), in step S2, the microcomputer block 17 checks the contents of the XDS packet when digitizing and recording the video signal input via the A/V input unit 20 or the TV tuner 21, and determines in step S3 whether or not the frequency information for viewing limit is present in the XDS packet.

When it is determined in step S3 that the frequency information for viewing limit is not present in the XDS packet (NO), the microcomputer block 17 returns to the processing in step S2. When it is determined in step S3 that the frequency information for viewing limit is present in the XDS packet (YES), the microcomputer block 17 records the frequency information and the video signal in a corresponded manner.

Thereafter, in step S4, the microcomputer block 17 determines whether or not a request is made to output the 480p video signal when reproducing the video signal, and when it is determined that a request is not made (NO), the microcomputer block 17 returns to the processing in step S2.

When it is determined in step S4 that a request is made to output the 480p video signal (YES), in step S5, the microcomputer block 17 determines whether or not the frequency information recorded in correspondence to the video signal substantially exceeds the frequency preset in the memory unit 17b by viewer's operating the key input unit 26.

When it is determined in step S5 that the frequency information of the video signal does not substantially exceed the frequency set by the viewer (NO), the microcomputer block 17 returns to the processing in step S2.

When it is determined in step S5 that the frequency information of the video signal substantially exceeds the frequency set by the viewer (YES), in step S6, the microcomputer block 17 forcibly stops an output of the video signal, masks the display screen of the TV receiver 25, and controls to notify that the program is limited for viewing, so that viewing limit is performed.

In other words, when the video signal input via the A/V input unit 20 or the TV tuner 21 is the 480i video signal and contains the frequency information for viewing limit, this optical disk recording/reproducing apparatus also records the frequency information together with the video signal in a corresponded manner.

When a request is made to output the 480p video signal when being reproduced, it is determined whether or not the frequency information substantially exceeds the frequency set by the viewer. When exceeds, the microcomputer block 17 stops an output of the video signal, masks the display screen of the TV receiver 25, and controls to notify that the program is limited for viewing. Thus, the viewing limit can be accurately performed.

FIG. 3 is a flowchart showing another example of the control operation using the viewing controller 17c. That is, when started (step S7), in step S8, the microcomputer block 17 checks the contents of the XDS packet when digitizing and recording the video signal input via the A/V input unit 20 or the TV tuner 21. In step S9, the microcomputer block 17 determines whether or not the frequency information for viewing limit is present in the XDS packet.

When it is determined in step S9 that the frequency information for viewing limit is not present in the XDS packet (NO), the microcomputer block 17 returns to the processing in step S8. When it is determined in step S9 that the frequency information for viewing limit is present in the XDS packet (YES), the frequency information and the video signal are recorded in a corresponded manner.

Thereafter, in step S10, the microcomputer block 17 determines whether or not a request is made to output the 480p video signal when being reproduced, and when it is determined that a request is not made (NO), the microcomputer block 17 returns to the processing in step S8.

When it is determined in step S10 that a request is made to output the 480p video signal (YES), in step S11, the microcomputer block 17 controls to forcibly output the 480i video signal containing the frequency information for viewing limit.

Thus, the TV receiver 25 can detect the frequency information for viewing limit from the input video signal and can achieve normal viewing limit.

FIGS. 2 and 3 describe the case where the input video signal is temporarily recorded and reproduced, but the optical disk recording/reproducing apparatus is not limited thereto and can similarly perform viewing limit operation also when converting the 480i video signal into the 480p video signal in real-time and outputting the same while recording the 480i video signal input via the A/V input unit 20 or the TV tuner 21.

The present invention is not limited to the above embodiment, and the constituents can be variously modified and embodied within the scope without departing from the spirit in the practice. A plurality of constituents disclosed in the embodiment can be appropriately combined to form various inventions. For example, some constituents may be deleted from all the constituents shown in the embodiment. Further, constituents according to different embodiments may be appropriately combined.

1. A video signal receiving apparatus comprising:
a receiving unit configured to receive a video signal on which frequency information for viewing limit is multiplexed during a video blanking period of a specific line in an interlace system;
an output unit configured to selectively output the video signal received in the receiving unit in an interlaced state or in a state of being converted into a progressive video signal;
a detecting unit configured to detect frequency information for viewing limit which is multiplexed during the blanking period from the video signal received in the receiving unit; and
a controller configured to, when the output unit is requested to output a progressive video signal in a state where the frequency information is detected in the detecting unit, limit an output of the video signal from the output unit.

2. A video signal receiving apparatus according to claim 1, wherein, when the output unit is requested to output a progressive video signal in a state where the frequency information detected in the detecting unit exceeds a preset frequency for viewing limit, the controller controls to stop an output of the video signal from the output unit.

3. A video signal receiving apparatus according to claim 2, wherein the controller outputs a signal for notifying a viewing limit.

4. A video signal receiving apparatus according to claim 1, wherein, when the output unit is requested to output a progressive video signal in a state where the frequency information is detected in the detecting unit, the controller controls to cause the output unit to output an interlace video signal.

5. A video signal receiving apparatus according to claim 1, 2, 3, or 4, wherein the receiving unit can receive a 480i video signal, and the output unit can convert a 480i video signal into a 480p video signal.

6. A video signal receiving method comprising:
receiving a video signal on which frequency information for viewing limit is multiplexed during a video blanking period of a specific line in an interlace system;
selectively outputting the received video signal in an interlaced state or in a state of being converted into a progressive video signal;
detecting the frequency information for viewing limit which is multiplexed during the video blanking period from the received video signal; and
when a request is made to output the progressive video signal in a state where the frequency information is detected, limiting an output of the video signal.

7. A video signal receiving method according to claim 6, wherein the limiting an output of the video signal limits to stop an output of the video signal when a request is made to output the progressive video signal in a state where the detected frequency information exceeds a preset frequency for viewing limit.

8. A video signal receiving method according to claim 7, wherein the limiting an output of the video signal outputs a signal for notifying a viewing limit.

9. A video signal receiving method according to claim 6, wherein the limiting an output of the video signal limits to output the interlace video signal when a request is made to output the progressive video signal in a state where the frequency information is detected.

10. A video signal recording/reproducing apparatus comprising:
a recording unit configured to record in a recording medium a video signal on which frequency information for viewing limit is multiplexed during a video blanking period of a specific line in an interlace system;
a reproducing unit configured to reproduce a video signal from the recording medium and selectively output the same in an interlaced state or in a state of being converted into a progressive video signal;
a detecting unit configured to detect the frequency information for viewing limit which is multiplexed during the video blanking period from the video signal reproduced in the reproducing unit; and
a controller configured to, when the reproducing unit is requested to output a progressive video signal in a state where the frequency information is detected in the detecting unit, limit an output of the video signal from the reproducing unit.

11. A video signal recording/reproducing apparatus according to claim 10, wherein, when the reproducing unit is requested to output a progressive video signal in a state where the frequency information detected in the detecting unit exceeds a preset frequency for viewing limit, the controller limits to stop an output of the video signal from the reproducing unit.

12. A video signal recording/reproducing apparatus according to claim 11, wherein the controller outputs a signal for notifying a viewing limit.

13. A video signal recording/reproducing apparatus according to claim 10, wherein, when the reproducing unit is requested to output a progressive video signal in a state where the frequency information is detected in the detecting unit, the controller limits to output an interlace video signal from the reproducing unit.

14. A video signal recording/reproducing apparatus according to claim 10, 11, 12 or 13, wherein the recording unit can record a 480i video signal in the recording medium, and the reproducing unit can convert a 480i video signal reproduced from the recording medium into a 480p video signal to output the same.

15. A video signal recording/reproducing method comprising:
recording in a recording medium a video signal on which frequency information for viewing limit is multiplexed during a video blanking period of a specific line in an interlace system;
reproducing the video signal from the recording medium and selectively outputting the same in an interlaced state or in a state of being converted into a progressive video signal;
detecting the frequency information for viewing limit which is multiplexed during the video blanking period from the reproduced video signal; and
when a request is made to output the progressive video signal in a state where the frequency information is detected, limiting an output of the video signal.

16. A video signal recording/reproducing method according to claim 15, wherein the limiting an output of the video signal limits to stop an output of the video signal when a request is made to output the progressive video signal in a state where the detected frequency information exceeds a preset frequency for viewing limit.

17. A video signal recording/reproducing method according to claim 16, wherein the limiting an output of the video signal outputs a signal for notifying a viewing limit.

18. A video signal recording/reproducing method according to claim 15, wherein the limiting an output of the video signal limits to output the interlace video signal when a request is made to output the progressive video signal in a state where the frequency information is detected.
